(19) United States
(12) Patent Application Publication
(10) Pub. No.: US 2007/0260504 A1
(43) Pub. Date: Nov. 8, 2007

(54) METHOD OF SOLVING AN EMERGENCY DEPARTMENT'S STAFFING PROBLEMS ASSOCIATED WITH PHYSICIANS PARTICIPATING IN ON-CALL SERVICES

(76) Inventors: Max A. Hockenberry, Charlotte, NC (US); Steve V. Worthy, Charlotte, NC (US)

Correspondence Address: HAMMER & HANF, PC, 3125 SPRINGBANK LANE, SUITE G, CHARLOTTE, NC, 28226, US

(21) Appl. No.: 11/682,467

(22) Filed: Mar. 6, 2007

Related U.S. Application Data
(60) Provisional application No. 60/798,428, filed on May 5, 2006.

(51) Int. Cl. G06Q 10/00

(52) U.S. Cl. 705/9

(57) ABSTRACT

A method of solving a hospital's Emergency Department staffing problems associated with physicians participating in on-call services includes the following steps. Designing a non-qualified deferred compensation plan that includes a personal service agreement between the physicians and the hospital which includes the physicians receiving the non-qualified deferred compensation plan in exchange for participating in on-call services. Implementing said non-qualified deferred compensation plan.

### RELATED APPLICATION

This application claims the benefit of U.S. Provisional Patent Application Ser. No. 60/798,428 filed May 5, 2006.

### FIELD OF INVENTION

The instant application relates to a method of solving a hospital's Emergency Department staffing problems associated with physicians participating in on-call services.

### BACKGROUND OF THE INVENTION

Hospitals are faced with providing emergency medical services to patients in the emergency room and emergency department locations. Thus, whether the physicians are at the hospital working or away from the hospital on personal time, physicians are faced with the task of providing medical services to emergency patients as they come through the door unassigned. This type of service is known as providing unassigned “on-call” Emergency Department (ED) Coverage. The historical view of on-call ED services in exchange for admitting and clinical privileges, ethical responsibilities, and a means of building a private medical practice are being altered by current conditions in healthcare.

The traditional approach to on-call service is being reshaped by the changing healthcare landscape. Emergency rooms are experiencing dramatic increases in the number of uninsured or underinsured patients. Also, in today's litigious environment, mal-practice lawsuits are escalating forcing medical liability insurance rates to increase. As a result of these factors, physicians are less willing to participate in unassigned patient on-call services. As a result of the medical professional's approach to participation, hospitals are increasingly being forced to compensate the physicians for providing these on-call services.

Hospitals are challenged by the shortage of medical professional specialties available and willing to take unassigned call. The situation in the healthcare industry is very similar to other industries where the issues are how to align the vision and needs of the organization, in this case the hospitals, with that of the key people that drive the hospital's revenues and profits, in this case the key people are the medical specialists, or physicians. The problem for hospitals is being magnified by the growth of private competing ventures, such as outpatient clinics and specialty surgery centers where the physicians are not required to accept unassigned patients or participate in Emergency Department on-call services. These private ventures are taking away considerable revenue from the hospitals by providing alternative delivery venues that do not require the physicians to participate in on-call services.

One current practice to encourage physicians to participate in on-call services is for hospitals to provide compensation for ‘on-call’ services, also know as the cash-for-call approach or a per diems approach. The cash-for-call approach has many inherent disadvantages that do not align the needs or vision of a hospital with the physician. These disadvantages include: immediate rewards are not effective for long-term solutions; taxation of the reward diminishes the value; the compensation is not distinctive; there is constant re-negotiations for the amount or the method that is used for determining who is included in the plan; and it is difficult to track what the hospitals benefit from their investment.

Thus, there is a need for a method of compensating physicians for participating in on-call services that is compatible with the needs and vision of a hospital.

The instant invention is designed to address these problems.

### SUMMARY OF THE INVENTION

The instant invention is a method of solving a hospital's Emergency Department staffing problems associated with physicians participating in on-call services. The method includes the following steps. Designing a non-qualified deferred compensation plan that includes a personal service agreement between the physicians and the hospital which includes the physicians receiving the non-qualified deferred compensation plan in exchange for participating in on-call services. Implementing said non-qualified deferred compensation plan.

### BRIEF DESCRIPTION OF THE DRAWINGS

For the purpose of illustrating the invention, there is shown in the drawings a form that is presented in one of the embodiments; it being understood, however, that this invention is not limited to the precise arrangements and instrumentalities shown.

FIG. 1 is a flow chart of one embodiment of the method of solving a hospital's Emergency Department staffing problems associated with physicians participating in on-call services.

FIG. 2 is a diagram of the relationship between the hospital and the physicians which includes the personal service agreement and the non-qualified deferred compensation plan.

FIG. 3 is a diagram of the on-going annual services supporting the non-qualified deferred compensation plan.

### DETAILED DESCRIPTION OF THE INVENTION

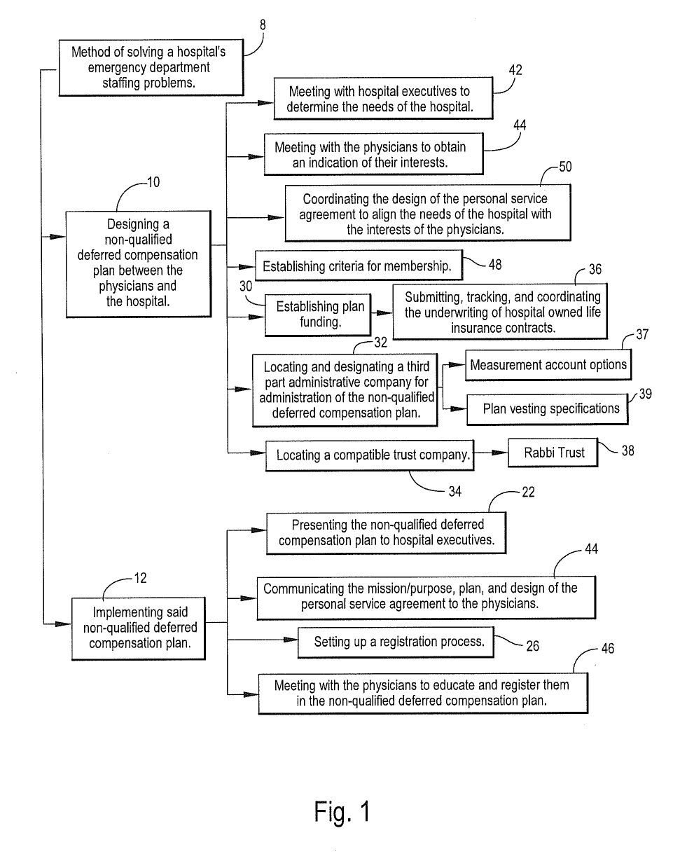

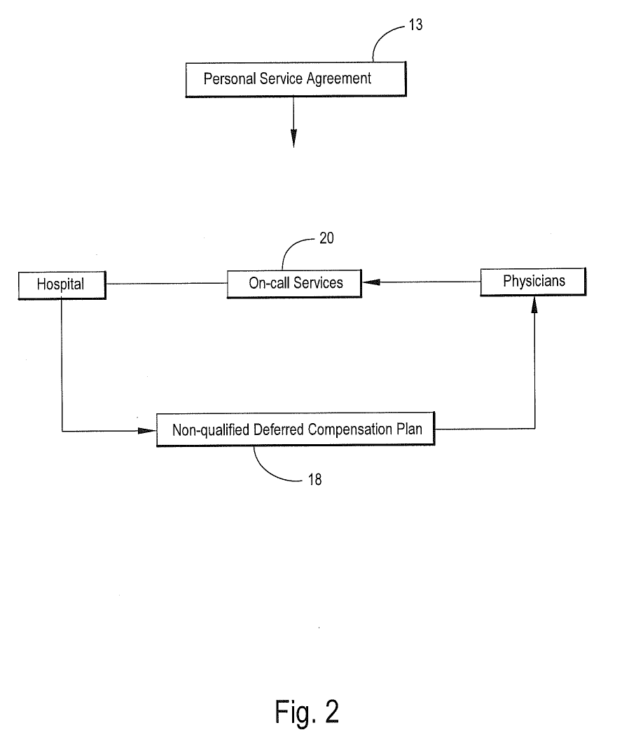

Referring to the drawings, wherein like numerals indicate like elements, there is shown in FIG. 1 an embodiment of a method 8 for solving a hospital's Emergency Department staffing problems associated with physicians participating in on-call services. Method 8 may include a step 10 (see FIG. 1) of designing a non-qualified deferred compensation plan 18 that includes a personal service agreement 13 between the physicians and the hospital which includes the physicians receiving non-qualified deferred compensation plan 18 in exchange for participating in on-call services 20 (see FIG. 2). Method 8 may also include a step 12 of implementing said non-qualified deferred compensation plan 18. Method 8 may be for allowing a hospital to provide compensation to physicians for participating in on-call services 20 within the visions and the needs of the hospital.

Non-qualified deferred compensation plan 18 may be included in method 8 (see FIG. 1). Non-qualified deferred compensation plan 18 may be a plan for compensating the physicians for participating in on-call services 20. Non-qualified deferred compensation plan 18 may be any non-qualified deferred compensation plan. Non-qualified deferred compensation plan 18 may be any common form of incentive compensation that leading public and private companies use routinely to attract, reward and/or retain key talent. Non-qualified deferred compensation plan 18 may defer the compensation paid to the physicians for participating in on-call services 20 by multiplying the impact of the reward by compounding the accrual of cash awarded on a tax-deferred basis. Non-qualified deferred compensation plan 18 may allow the hospital to keep the cash throughout the deferral period where the cash may remain an asset of the hospital even though the cash has been set aside in a trust fund to offset the obligation. Non-qualified deferred compensation plan 18 may be designed to meet current federal regulations regarding both for-profit and not-for-profit organizations. These regulations may include: Employment Retirement Income Security Act (1974); American Jobs Creation Act Oct. 22, 2004 re: IRC 409A (fall 2004); and IRC457(f). Non-qualified deferred compensation plan 18 may be rewarded to physicians based on a set of working factors with regard to on-call services 20. The set of working factors may include, but are not limited to, frequency of call during the typical on-call period, professional liability risks, and the number of physicians available to participate in on-call services 20.

Personal service agreement 13 may be included in method 8 (see FIG. 2) as a part of the non-qualified deferred compensation plan 18. Personal service agreement 13 may include the physicians receiving from the hospital non-qualified deferred compensation plan 18 in exchange for participating in on-call services 20 at the hospital. Personal service agreement 13 may include any additional requirements for the physicians. As examples, to participate in non-qualified deferred compensation plan 18, personal service agreement 13 may require the physicians to adopt the hospital charity care policy, and/or accept Medicare and Medicaid.

Step 10, designing non-qualified deferred compensation plan 18 may be included in method 8 (see FIG. 1). Step 10 may be for the designing of non-qualified deferred compensation 18 to align the needs and vision of the hospital with the interests of the physicians. Step 10 may include designing non-qualified deferred compensation plan 18 to include personal service agreement 13 between the physicians and the hospital which includes the physicians receiving non-qualified deferred compensation plan 18 in exchange for participating in on-call services in the Emergency Department. Step 10 may include any steps for designing non-qualified deferred compensation plan 18. Step 10 of designing non-qualified deferred compensation 18 may include, but is not limited to, the following steps: a step 42 of meeting with hospital executives to determine the needs of the hospital; a step 44 of meeting with the physicians to obtain an indication of their interests; a step 50 of coordinating the design of personal service agreement 13 to align the needs of the hospital with the interests of the physicians; a step 48 of establishing criteria for membership; a step 30 of establishing plan funding; a step 36 of submitting, tracking and coordinating the underwriting of hospital owned life insurance contracts (or other suitable investments, such as, but not limited to, mutual funds or annuities); a step 32 of locating and designating a third party administrative company for administration of non-qualified deferred compensation plan 18; and a step 34 of locating and coordinating a compatible trust company. Step 10 of designing non-qualified deferred compensation plan 18 may further include, but is not limited to the following (not shown in Figures): meeting with each medical professional; presenting the objectives and design of non-qualified deferred compensation plan 18; presenting personal service agreement 13; providing feedback from physicians regarding non-qualified deferred compensation plan 18 and personal service agreement 13; adjusting non-qualified deferred compensation plan 18 and personal service agreement 13 as necessary; and being a resource for all physicians to answer questions and express concerns regarding non-qualified deferred compensation plan 18 and personal service agreement 13.

Step 42 of meeting with the hospital executives to determine the needs of the hospital may include any steps, including, but not limited to, the following (not shown in the Figures): discovering the initial interests and current needs of the hospital via a conference call with hospital executives; discussing the current environment on a national level regarding the issues of paying for on-call services with hospital executives; discussing the level of attention and need for paying for on-call services to specific situations; discussing the various industry solutions that have been put in place as well as the positives and negatives of each solution; presenting an overview of said personal service agreement 13 to the hospital executives; and coordinating follow up information inquiries with hospital executives and physicians.

Step 12 of implementing non-qualified deferred compensation plan 18, may be included in method 8 (see FIG. 1). Step 12 may be for implementing non-qualified deferred compensation plan 18. Step 12 may include any steps for implementing non-qualified deferred compensation plan 18. Step 12 may include, but is not limited to, the following steps: a step 22 of presenting non-qualified deferred compensation plan 18 to the hospital executives; a step 44 of communicating the mission/purpose, plan and design of personal service agreement 13 to the physicians; a step 26 of setting up a registration process; and a step 46 of meeting with the physicians to educate and register them in non-qualified deferred compensation plan 18. Step 12 may further include (not shown in the figures), but is not limited to: providing prototype documents for non-qualified deferred compensation plan 18 to appropriate tax professionals to provide a tax opinion on the documents; designing parameters as directed by hospital executives; creating a presentation of personal service agreement 13; working with hospital executives and physicians in the creation of personal service agreement 13; designing and establishing an oversight board within the hospital including, but not limited to, designing a set of board membership criteria, creating a board mission or purpose statement, establishing funding criteria, and defining and modeling outcomes; designing and establishing a physician committee including, but not limited to, establishing committee membership criteria, creating committee mission and purpose, and creating parameters of funding personal service agreement 13; consulting with the physician committee and/or the hospital executives regarding funding allocation determination; consulting with an attorney regarding the design of a legally permissible personal service agreement 13; locating the third party administrative company for non-qualified deferred compensation plan 18 design and administration; consulting with the third party administrative company to design a plan agreement that coordinates with personal service agreement 13; coordinating the work of the third party administrative company with the hospital; coordinating the creation of rabbi trust 38; providing on-going service and support to the physicians; designing the funding analytics for non-qualified deferred compensation plan 18; and presenting non-qualified deferred compensation plan 18 to the hospital executives for final resolution and approval.

Step 46 of meeting with the physicians to educate and register them into non-qualified deferred compensation plan 18 may include any steps for meeting with the physicians to register the physicians. Step 46 may include, but is not limited to: educating and communicating to the physicians the non-qualified deferred compensation plan 18; obtaining registration documents for non-qualified deferred compensation plan 18; and updating the hospital executives on enrollment for keeping the hospital executives up to date on how non-qualified deferred compensation plan 18 and personal service agreement 13 are functioning. This may allow hospital executives to adjust non-qualified deferred compensation plan 18 or personal service agreement 13 as necessary.

Step 36 of submitting, tracking and coordinating the underwriting and issuance of hospital owned life insurance contracts may be included in step 30 of establishing plan funding (see FIG. 1). Step 36 may be for submitting, tracking and coordinating the underwriting and issuance of hospital owned life insurance contracts. Step 36 may include any steps for submitting, tracking and coordinating the underwriting and issuance of hospital owned life insurance contracts. Hospital owned life insurance contracts may informally fund non-qualified deferred compensation plan 18. Other investments may also informally fund non-qualified deferred compensation plan 18, for example, but not limited to, investments in mutual funds or annuities. Step 36 may include, but is not limited to, the following steps (not shown in Figures): confirming funding strategy for non-qualified deferred compensation plan 18; executing underwriting for corporate owned life insurance contracts; issuing process for corporate owned life insurance contracts; finalizing funding analytics; and finalizing funding implementation.

Hospital owned life insurance is a form of life insurance known as Corporate Owned Life Insurance or COLI. The hospital owned life insurance contracts may be a type of life insurance policy taken out by the hospital on the lives of the physicians who participate in non-qualified deferred compensation plan 18. Under this type of setup, the hospital may pay the premium on the insurance and may also be the policies' primary beneficiary. The hospital owned life insurance contracts may recover the expenses associated with paying for on-call services. The recovery of expenses may be done over time because the hospital will receive the death benefits of the corporate owned life insurance contracts issued on the lives of the physicians, which essentially may fund plan 18.

Measurement account options 37 may be tracked, reported and posted by the administrator or their designated third party administrative company in step 32 (see FIG. 1). Measurement account option 37 may create a measurable value that the participating physician can view/monitor where the potential future award can be linked to their personal financial planning. The physician participants in non-qualified deferred compensation plan 18 may direct their measurement accounts into a variety of investment options selected by the hospital where the assets are held in trust and managed in aggregate by the plan administrator or their designee. Measurement account option 37 may include a multiple number of funds to allow for diversification of risk and reward. These funds will probably be more than two (2) and can easily include twenty (20) or more funds from which the participants can select. These funds may include, but are not limited to, twelve (12) to sixteen (16) funds selected by the hospital. Measurement account option 37 may allow the participating physicians to change between measurement accounts upon demand. The reward allocation from measurement account options 37 may be communicated to the physicians in any form, including, but not limited to, via a secure Web-based platform as well as quarterly paper statements.

Plan vesting specifications 39 may be coordinated with the third party administrative company in step 32 (see FIG. 1). Plan vesting specifications 39 may be the amount of time required for the physicians to participate in plan 18 before their rights accrue. Plan vesting specifications 39 may provide incentive for the physicians to continue under personal service agreement 13. Plan vesting specifications may include any amount of time for the plan to vest. The amount of time for the plan to vest may include, but is not limited to, five (5) years from the date of enrollment, ten (10) years from the date of enrollment, the age of sixty (60), or any period longer than five (5) years.

Rabbi trust 38 may be established in step 34 of locating and designating a compatible trust company of method 8 (see FIG. 1). Rabbi trust 38 may be any rabbi trust. Rabbi trust 38 may informally fund the liability of the non-qualified deferred compensation plan 18. Rabbi trust 38 may be any trust that may be created for the purpose of supporting the non-qualified benefit obligations of the hospital to the physicians. Rabbi trust 38 may create assurance for the physicians by restricting the assets within the trust according to the terms of the trust agreement.

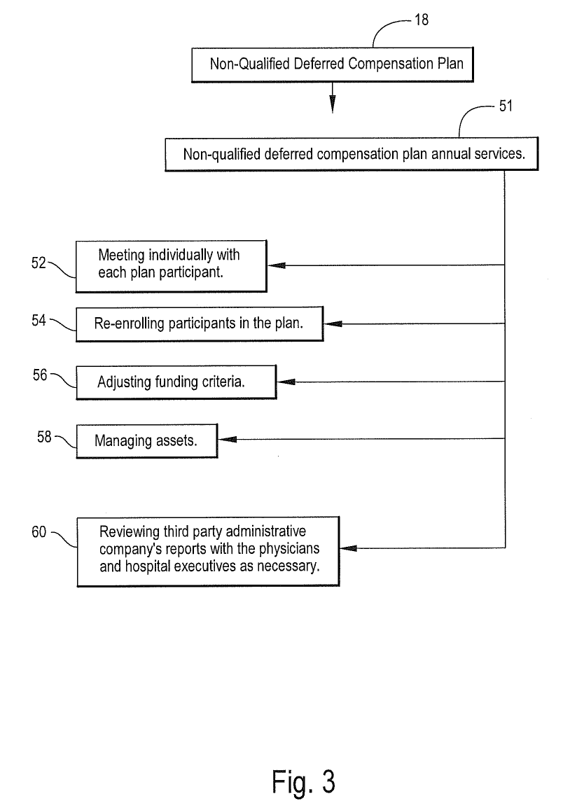

Non-qualified deferred compensation plan 18 may include annual services 51 (see FIG. 3). Annual services 51 may include any annual services. Annual services 51 may include, but are not limited to, an annual service 52 of meeting individually with each plan participant, an annual service 54 of re-enrolling the physicians into non-qualified deferred compensation plan 18, an annual service 56 of adjusting funding criteria for non-qualified deferred compensation plan 18, an annual service 58 of managing assets of non-qualified deferred compensation plan 18, and an annual service 60 of reviewing the third party administration company's reports with participating physicians and hospital executives as necessary. Annual services 51 may include, but is not limited to, the following actions (not shown in Figures): reviewing communication and annual registration strategy with hospital executives for non-qualified deferred compensation plan 18; providing an ongoing plan of service for non-qualified deferred compensation plan 18; coordinating annually individual meetings with each enrolled medical professional in non-qualified deferred compensation plan 18; coordinating annual re-registration for enrolled physicians; adjusting funding criteria as necessary; managing funding of non-qualified deferred compensation plan 18 on an ongoing basis; and reviewing the third party administrative company's reports with enrolled physicians and hospital executives as necessary.

In operation, method 8 provides an incentive through non-qualified deferred compensation plan 18 and personal service agreement 13 for physicians to participate in on-call services 20 at the hospital (See FIG. 2). The physicians will be rewarded for participating in on-call services 20 with non-qualified deferred compensation plan 18. Plan 18 provides a long term solution for an incentive for on-call services 20 by deferring the compensation on a tax deferred basis, thus, taxation of the reward does not diminish the value. Plan 18 may include the establishment of rabbi trust 38 which may provide more incentive to the physicians to participate in the plan by protecting the participants according to the terms of the trust agreement. Non-deferred compensation plan 18 may include measurement account options 37 where the physicians may view, direct and monitor their measurement account value.

Method 8 also provides a way of encouraging the physicians to participate in on-call services that meets the needs of the hospital. Method 8 provides non-qualified deferred compensation plan 18 that may be funded through hospital owned life insurance contracts (or other investments, such as, but not limited to, mutual funds or annuities). The hospital owned life insurance contracts may provide the funding necessary for implementing plan 18.

The present invention may be embodied in other forms without departing from the spirit and the essential attributes thereof, and, accordingly, reference should be made to the appended claims, rather than to the foregoing specification, as indicated in the scope of the invention.

We claim:

1. A method of solving a hospital's Emergency Department staffing problems associated with physicians participating in on-call services comprising the steps of:
designing a non-qualified deferred compensation plan that includes a personal service agreement between the physicians and the hospital which includes the physicians receiving said non-qualified deferred compensation plan in exchange for participating in on-call services; and
implementing said non-qualified deferred compensation plan.

2. The method according to claim 1 where said step of designing a non-qualified deferred compensation plan includes the steps of:
meeting with hospital executives to determine the needs of the hospital;
meeting with the physicians to obtain an indication of their interests.
coordinating the design of said personal service agreement to align the needs of the hospital with the interests of the physicians;
establishing criteria for membership;
establishing plan funding;
locating and designating a third party administrative company for administration of said non-qualified deferred compensation plan; and
locating and coordinating a compatible trust company.

3. The method according to claim 2 where said step of establishing plan funding includes the step of submitting, tracking and coordinating the underwriting of hospital owned life insurance contracts.

4. The method according to claim 2 where said compatible trust company establishing a rabbi trust to informally fund the liability of said non-qualified deferred compensation plan.

5. The method according to claim 1 where said step of implementing said non-qualified deferred compensation plan comprises the steps of:
presenting said non-qualified deferred compensation plan to the hospital executives;
communicating the mission/purpose, plan, and design of the personal service agreement to the physicians;
meeting with physicians to educate them on said non-qualified deferred compensation plan;
setting up a registration process; and
registering the physicians into said non-qualified deferred compensation plan.

6. The method of claim 1 where said personal service agreement further including:
adopting the hospital charity program; and
accepting Medicare and Medicaid.

7. The method of claim 1 where said non-qualified deferred compensation plan including annual services.

8. The method of claim 7 where said annual services comprising:
meeting individually with each plan participant;
re-enrolling participating physicians into said non-qualified deferred compensation plan;
adjusting funding criteria;
managing assets; and
reviewing said third party administration companies reports with participants and hospital executives as necessary.

9. The method of claim 1 where said non-qualified deferred compensation plan further including plan vesting specifications.

10. The method of claim 9 where said plan vesting specifications including:
five (5) years from the date of enrollment;
ten (10) years from the date of enrollment;
age of sixty(60); and
any period longer than five (5) years.

11. The method of claim 1 where said non-qualified deferred compensation plan further includes measurement account investment options.

12. The method of claim 1 where said non-qualified deferred compensation plan being rewarded to physicians based on a set of working factors.

13. The method of claim 12 where said set of working factors include:
frequency of call during the typical on-call period;
professional liability risks; and
the number of physicians available to participate in the on-call service.

14. The method of claim 1 where said step of meeting with hospital executives to determine the needs of the hospital includes the steps of:
discovering initial interest and current needs of hospital via conference call with hospital executives;
discussing the current environment on a national level regarding the issues of paying for on-call services with the hospital executives;
discussing the level of attention and need for paying for on-call services to specific situations;
discussing the various industry solutions that have been put in place as well as the positives and negatives of each solution;
presenting overview of said personal service agreement to the hospital executives; and
coordinating follow up information inquiries with the hospital executives and the physicians.

15. The method of claim 1 where said step of implementing said non-qualified deferred compensation plan further includes the steps of:
providing prototype documents for said non-qualified deferred compensation plan to appropriate tax professionals to provide tax opinion on the documents;
designing parameters as directed by the governing board or boards and hospital executives;
creating a presentation of said non-qualified deferred compensation plan;
working with the hospital executives and the medical professionals in the creation of said non-qualified deferred compensation plan;
coordinating the design of an oversight board within the hospital, including: designing a set of board membership criteria; creating a board mission or purpose statement; establishing funding criteria; defining and modeling outcomes; and establishing said oversight board
designing and establishing a physician committee, including: establishing committee membership criteria; creating committee mission and purpose; and creating parameters of funding said non-qualified deferred compensation plan;
consulting with said physician committee and/or the hospital executives regarding funding allocation determination;
consulting with an attorney regarding the design of a legally permissible personal service agreement;
locating a third party administrative company for said non-qualified deferred compensation plan design and administration;
consulting with said third party administrative company to design a plan agreement that coordinates with said personal service agreement;
coordinating the work of said third party administrative company with the hospital;
coordinating the creation of a rabbi trust; and
presenting said non-qualified deferred compensation plan to the hospital executives for final resolution and approval.

16. The method of claim 3 where said step of meeting with physicians to educate them on said non-qualified deferred compensation plan includes the steps of:
meeting with each medical professional;
presenting said non-qualified deferred compensation plan objectives and design;
presenting said non-qualified deferred compensation plan;
providing feedback from the physicians regarding said non-qualified deferred compensation plan and said personal service agreement;
adjusting said non-qualified deferred compensation plan and said personal service agreement as necessary; and
being a resource for all physicians to answer questions and express concerns regarding said non-qualified deferred compensation plan and said personal service agreement.

17. The method of claim 3 where said step of registering the physicians into said non-qualified deferred compensation plan includes the steps of:
educating and communicating to the physicians said non-qualified deferred compensation plan;
obtaining plan registration documents; and
updating hospital executives on status of plan registration.

18. The method of claim 2 where said step of designing said non-qualified deferred compensation plan further includes the steps of:
confirming plan funding strategy;
locating corporate owned life insurance contracts;
implementing underwriting for corporate owned life insurance contracts;
issuing process for corporate owned life insurance contracts;
finalizing funding analytics; and
finalizing funding implementation.

19. A method of solving a hospital's Emergency Department staffing problems associated with physicians participating in on-call services comprising the steps of:
providing a non-qualified deferred compensation plan;
providing a personal service agreement between the physicians and the hospital which includes the physicians receiving said non-qualified deferred compensation plan in exchange for participating in on-call services;
establishing criteria for membership in said non-qualified deferred compensation plan;
establishing plan funding;
establishing a third party administrative company for administering of said non-qualified deferred compensation plan; and
establishing and coordinating a compatible trust company.

20. A method of solving a hospital's Emergency Department staffing problems associated with physicians participating in on-call services comprising the steps of:
designing a non-qualified deferred compensation plan that includes a personal service agreement between the physicians and the hospital which includes the physicians receiving said non-qualified deferred compensation plan in exchange for participating in on-call services, including the following steps:
meeting with hospital executives to determine the needs of the hospital including the steps of:
discovering initial interest and current needs of hospital via conference call with hospital executives;
discussing the current environment on a national level regarding the issues of paying for on-call services with the hospital executives;
discussing the level of attention and need for paying for on-call services to specific situations;
discussing the various industry solutions that have been put in place as well as the positives and negatives of each solution;
presenting overview of said personal service agreement to the hospital executives; and
coordinating follow up information inquiries with the hospital executives and the physicians;
meeting with the physicians to obtain an indication of their interests.
coordinating the design of said personal service agreement to align the needs of the hospital with the interests of the physicians;
establishing criteria for membership;
establishing plan funding including the steps of:
submitting, tracking and coordinating the underwriting of hospital owned life insurance contracts; and
designing the funding analytics for said non-qualified deferred compensation plan;
locating and designating a third party administrative company for administration of said non-qualified deferred compensation plan; and
locating and coordinating a compatible trust company;
confirming plan funding strategy;
locating corporate owned life insurance contracts;
implementing underwriting for corporate owned life insurance contracts;
issuing process for corporate owned life insurance contracts;
finalizing funding analytics;
finalizing funding implementation;
said compatible trust company establishing a rabbi trust to informally fund the liability of said non-qualified deferred compensation plan; and
said personal service agreement further including:
adopting the hospital charity program; and
accepting Medicare and Medicaid;
said non-qualified deferred compensation plan including annual services comprising:
meeting individually with each plan participant;
re-enrolling participating physicians into said non-qualified deferred compensation plan;
adjusting funding criteria;
managing assets; and
reviewing said third party administration company's reports with participants and hospital executives as necessary;
said non-qualified deferred compensation plan further including plan vesting specifications comprising:
five (5) years from the date of enrollment;
ten (10) years from the date of enrollment;
age of sixty(60); and
any period longer than five (5) years;
said non-qualified deferred compensation plan further includes measurement account investment options;
said non-qualified deferred compensation plan being rewarded to physicians based on a set of working factors, including:
frequency of call during the typical on-call period;
professional liability risks; and
the number of physicians available to participate in the on-call service;
implementing said non-qualified deferred compensation plan, including the steps of:
presenting said non-qualified deferred compensation plan to the hospital executives;
communicating the mission/purpose, plan, and design of the personal service agreement to the physicians;
setting up a registration process;
meeting with physicians to educate them on said non-qualified deferred compensation plan, including the steps of:
meeting with each medical professional;
presenting said non-qualified deferred compensation plan objectives and design;
presenting said non-qualified deferred compensation plan;
providing feedback from the physicians regarding said non-qualified deferred compensation plan and said personal service agreement;
adjusting said non-qualified deferred compensation plan and said personal service agreement as necessary; and
being a resource for all physicians to answer questions and express concerns regarding said non-qualified deferred compensation plan and said personal service agreement; and
registering the physicians into said non-qualified deferred compensation plan, including the steps of:
educating and communicating to the physicians said non-qualified deferred compensation plan;
obtaining plan registration documents; and
updating hospital executives on status of plan registration
providing prototype documents for said non-qualified deferred compensation plan to appropriate tax professionals to provide tax opinion on the documents;
designing parameters as directed by the governing board or boards and hospital executives;
creating a presentation of said non-qualified deferred compensation plan;
working with the hospital executives and the physicians in the creation of said non-qualified deferred compensation plan;
coordinating the design of an oversight board within the hospital, including:
designing a set of board membership criteria;
creating a board mission or purpose statement;
establishing funding criteria;
defining and modeling outcomes; and
establishing said oversight board;
designing and establishing a physician committee, including:
establishing committee membership criteria;
creating committee mission and purpose; and
creating parameters of funding said non-qualified deferred compensation plan; and
consulting with said physician committee and/or the hospital executives regarding funding allocation determination;
consulting with an attorney regarding the design of a legally permissible personal service agreement;
locating a third party administrative company for said non-qualified deferred compensation plan design and administration;
consulting with said third party administrative company to design a plan agreement that coordinates with said personal service agreement;
coordinating the work of said third party administrative company with the hospital;
coordinating the creation of a rabbi trust; and
presenting said non-qualified deferred compensation plan to the hospital executives for final resolution and approval.
